(19) United States
(12) Patent Application Publication
(10) Pub. No.: US 2015/0278715 A1
(43) Pub. Date: Oct. 1, 2015

(54) METHODS, SYSTEMS AND PROCESSORS FOR AUTOMATED CHILD CARE BOOKING CANCELLATION

(71) Applicant: Kindy Now Pty Ltd, Elwood (AU)

(72) Inventors: Sean COLLINS, Elwood (AU); Matt MAYER, Hong Kong (HK)

(21) Appl. No.: 14/529,644

(22) Filed: Oct. 31, 2014

(30) Foreign Application Priority Data
Mar. 27, 2014 (AU) 2014100303

(51) Int. Cl. G06Q 10/02

(52) U.S. Cl. CPC G06Q 10/02

(57) ABSTRACT

A processor for automated child care booking management. The processor includes at least one microprocessor, a memory, and a communications interface for providing access to a communications conduit. The memory includes instructions executable by the at least one microprocessor such that the processor is operable to: each of a plurality of personal computing devices having an associated child and an associated electronic display, send child care booking information indicative of a booking for child care center for the associated child for display on the associated electronic display; receive from one of the plurality of personal computing devices booking cancelation information indicative of cancelation of the booking for child care for the child associated with the one of the plurality of personal computing devices; and modify booking data stored in memory using the booking cancellation information.

### RELATED APPLICATION

The present application claims priority to Australian Innovation Patent No. 2014100303, filed Mar. 27, 2014, the disclosure of which is hereby incorporated by reference herein in its entirety.

### TECHNICAL FIELD

The disclosure herein generally relates to methods, systems and processors for automated child care booking cancelation.

### BACKGROUND

The management of bookings for child care may, if not efficiently managed, impact on the child care provider's profitability and/or viability. A booking cancelation, for example by taking a phone call, may be burdensome for child care providers. A booking may be cancelled because a child is sick. The child's sickness may be discovered a short time before the booking, for example the morning of the booking, which is a busy time of the day for a parent. Parents may have to perform activities that compete with informing the child care center of the cancellation, for example getting other children ready for school, and find alternative arrangements for care of the sick child, etc. Unless it is easy for the parent to inform the child care center of the booking they may not do so.

The cancellation may be received at an unusual time, for example early in the morning when a child is discovered sick, and the child care provider may not be available to receive a phone cancellation.

Providing better methods, systems and processors for child care booking cancelation may be advantageous.

### SUMMARY

Disclosed herein is a method for automated child care booking management. The method comprises the step of, to each of a plurality of personal computing devices having an associated child and an associated electronic display, a processor sending child care booking information indicative of a booking for child care for the associated child for display on the associated electronic display. The method comprises the step of the processor receiving from one of the plurality of personal computing devices booking cancelation information indicative of cancelation of the booking for child care for the child associated with the one of the plurality of personal computing devices. The method comprises the step of the processor modifying booking data stored in memory using the booking cancellation information.

In an embodiment, the method is for automated child care booking management for a child care center. The booking for child care may be for child care at a child care center. The booking data may comprise child care center booking data.

Automated cancellations may not directly involve child care center staff. This may result in a reduction in child care center staff costs, and reduce the possibility of human error. The effort required by the user to cancel the booking may be easier than phoning. Making cancellations easier for the user may increase the percentage of child absences that the center is informed of in advance. Advanced notice of cancellations may enable a reduction of unneeded child care staff, which may save the child care center provider money. If the number of cancellations is sufficient, children normally cared for in different rooms of the child care center may be cared for in a single room. This may reduce, for example, staffing, lighting, and heating costs.

In an embodiment, the cancelation information is generated by a user interacting with the one of the plurality of personal computing devices. Each of the plurality of personal communication devices may have a user interface for the user to interact with. Each of the plurality of personal communication devices may have program instructions that configures the user interface. The program instructions are, generally, child care booking management program instructions. The interface may be configured to display child care availability information. The cancellation information may be sent by the one of the plurality of personal computing devices to the processor via a communications conduit. The communications conduit may comprise a network. The network may comprise the Internet. The processor sending and receiving may be via a communications interface of the processor that provides access to the communications conduit. The communications interface may comprise a network interface.

Booking cancellations may be made at generally any suitable location and time, especially in examples wherein the plurality of personal computing devices comprise at least one of a smart phone and a tablet computer.

In an embodiment, the processor provides an incentive for the receipt of the booking cancellation information. The incentive may be for the user for the receipt of the booking cancellation information from the one of the plurality of personal computing devices.

In an embodiment, the step of the processor modifying booking data stored in memory comprises the step of the processor subsequently modifying booking data stored in a memory of the processor or another memory. The processor may be in communication with another processor and the other memory may be that of the other processor. The processor and the other processor may be in communication via an application program interface (API). The other processor may have program instructions for child care management. The API may be defined by the child care management program instructions. The API may define hyper text transfer protocol requests. The API may define the transfer of information in JSON format.

Disclosed herein is a processor for automated child care booking management. The processor comprises at least one microprocessor, a memory, and a communications interface for providing access to a communications conduit. The memory comprises instructions executable by the at least one microprocessor such that the processor is operable to:

to each of a plurality of personal computing devices having an associated child and an associated electronic display, send child care booking information indicative of a booking for child care center for the associated child for display on the associated electronic display;

receive from one of the plurality of personal computing devices booking cancelation information indicative of cancelation of the booking for child care for the child associated with the one of the plurality of personal computing devices; and

modify booking data stored in memory using the booking cancellation information.

In an embodiment, the processor is for automated child care booking management for a child care center. The booking for child care may be for child care at a child care center. The booking data may be child care center booking data.

In an embodiment, the communications interface is a network interface. The communications conduit may comprise a network. The network may comprise the Internet.

In an embodiment, the cancelation information is generated by a user interacting with the one of the plurality of personal computing devices. Each of the plurality of personal communication devices may have a user interface for the user to interact with. Each of the plurality of personal communication devices may have program instructions that configures the user interface. The program instructions are, generally, child care booking management program instructions. The interface may be configured to display child care availability information. The cancellation information may be sent by the one of the plurality of personal computing devices to the processor via a communications conduit. The communications conduit may comprise a network. The network may comprise the Internet. The processor sending and receiving may be via a communications interface of the processor that provides access to the communications conduit. The communications interface may comprise a network interface.

In an embodiment, the processor is operable to provide an incentive for the receipt of the booking cancellation information. The incentive may be for the user of the one of the plurality of personal computing devices for the receipt of the booking cancellation information from the one of the plurality of personal computing device.

In an embodiment, the processor is operable to be in communication with another processor and the memory may be that of the other processor. The processor may be operable to be in communication with the other processor via an application program interface (API). The other processor may have program instructions for child care management. The API may be defined by the child care management program instructions. The API may define hyper text transfer protocol requests. The API may define the transfer of information in Java Script Object Notation (JSON) format.

Disclosed herein is a method for automated child care booking management. The method comprises the step of a personal computing device having an associated child and an associated electronic display receiving child care booking information indicative of a booking for child care for the associated child for display on the associated electronic display. The method comprises the step of the personal computing device sending cancellation information indicative of cancelation of the booking for child care to a processor, the booking cancellation information having been generated by a user interacting with the personal computing device.

An embodiment comprises the step of the booking cancellation information being sent to the processor for the processor to modify booking data stored in memory using the booking cancellation information. The booking data may be modified to indicate that the user has cancelled the booking for child care.

In an embodiment, the processor modifies the booking data stored in memory using the booking cancellation information. The processor may be in communication with another processor and may modify booking data stored in a memory of the other processor. The processor and the other processor may be in communication via an application program interface (API). The other processor may have program instructions for child care management. The API may be defined by the child care management program instructions. The API may define hyper text transfer protocol requests. The API may define the transfer of information in JSON format.

An embodiment comprises the step of an application on the personal computing device configuring a user interface.

In an embodiment, the cancellation information may be sent via a communications conduit. The communications conduit may comprise a network. The network may comprise the Internet. The processor sending and receiving may be via a communications interface of the processor that provides access to the communications conduit. The communications interface may comprise a network interface.

In an embodiment, the processor provides an incentive for the receipt of the booking cancellation information. The incentive may be for the user for the receipt of the booking cancellation information from the personal computing device.

Disclosed herein is a system for automated child care booking management. The system comprises a personal computing device and a processor arranged to communicate with each other, the personal computing device being arranged for a user to interact therewith to generate booking cancellation information indicative of cancelation of the booking for child care, the personal computing device being arranged to send the cancellation information indicative of cancelation of the booking for child care to the processor, and the processor being further arranged to modify booking data stored in memory using the booking cancellation information.

In an embodiment, the processor may be in communication with another processor and the memory may be that of the other processor. The processor and the other processor may be in communication via an application program interface (API). The other processor may have program instructions for child care management. The API may be defined by the child care management program instructions. The API may define hyper text transfer protocol requests. The API may define the transfer of information in JSON format. In an embodiment, the personal computing device and the processor are arranged to communicate with each other over a communications conduit. The communications conduit may comprise a network. The network may comprise the internet. The processor may comprise a communications interface. The communications interface may comprise a network interface.

Each of the plurality of personal communication devices may have a user interface and an application for configuring the user interface for an associated user to interact with.

In an embodiment, the processor provides an incentive for the receipt of the booking cancellation information. The incentive may be for the user for receipt of the booking cancellation information from the personal computing device.

Disclosed herein is processor readable tangible media including program instructions which when executed by a processor causes the processor to perform a method disclosed above.

Disclosed herein is a computer program for instructing a processor, which when executed by the processor causes the processor to perform a method disclosed above.

Any of the various features of each of the above disclosures, and of the various features of the embodiments described below, can be combined as suitable and desired.

### BRIEF DESCRIPTION OF THE FIGURES

Embodiments will now be described by way of example only with reference to the accompanying figures in which:

FIG. 1 shows an embodiment of a processor for automated child care booking management within an embodiment of a system for automated child care booking management.

FIG. 2 shows a flow chart of an embodiment of a method for automated child care booking management.

FIG. 3 shows yet another embodiment of a processor for automated child care booking management within another embodiment of a system for automated child care booking management.

FIG. 4 shows information generated by the processor of either one of FIG. 1 and FIG. 3.

FIG. 5 shows a flow chart of another embodiment of a method for automated child care booking management.

FIGS. 6 to 16 are screen shots of a user interface of a personal computing device.

### DESCRIPTION OF EMBODIMENTS

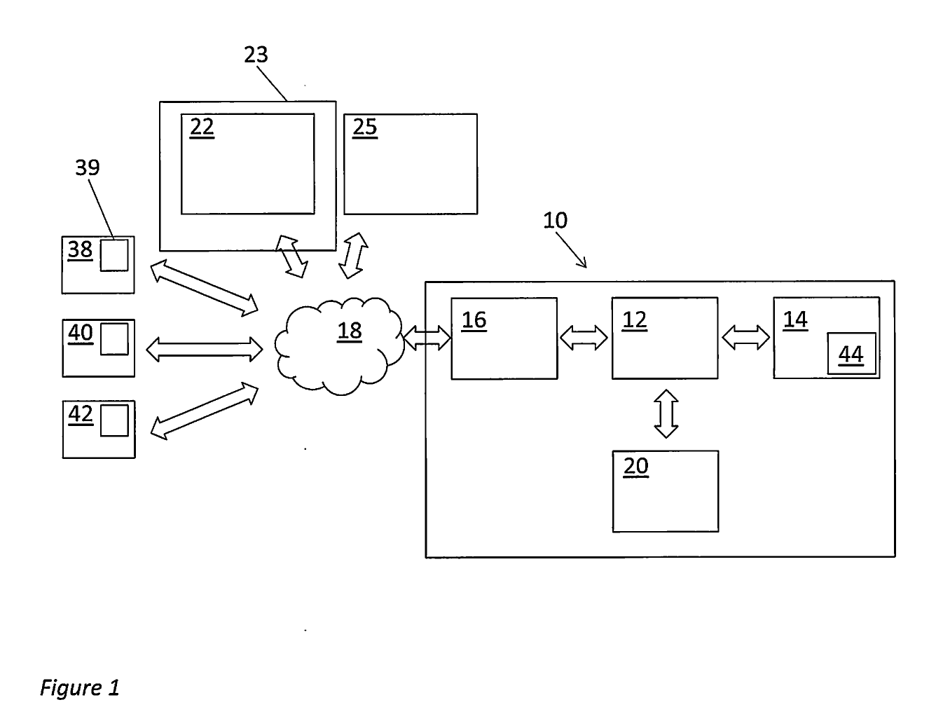

FIG. 1 shows an embodiment of a processor for automated child care booking management, the processor being generally indicated by the numeral 10. In this but not necessarily in all embodiments, the processor is for automated child care booking management for a child care center. The processor 10 has a microprocessor 12, memory 14, and a communications interface 16 for providing access to a communications conduit in the form of a computer network 18. The network 18 in this example is the internet 18.

A plurality of personal computing devices 38, 40, 42 are each configured to communicate with the processor 10 via the network 18. While three personal computing devices are shown in FIG. 1, there may be less (for example 2) or more (for example one of at least 50, 100 and 500). The plurality of personal computing devices are generally remote of the processor 10 and are operable by a plurality of users to manage bookings for the child care. In this but not necessarily in all embodiments the bookings are for booking for child care at the child care center.

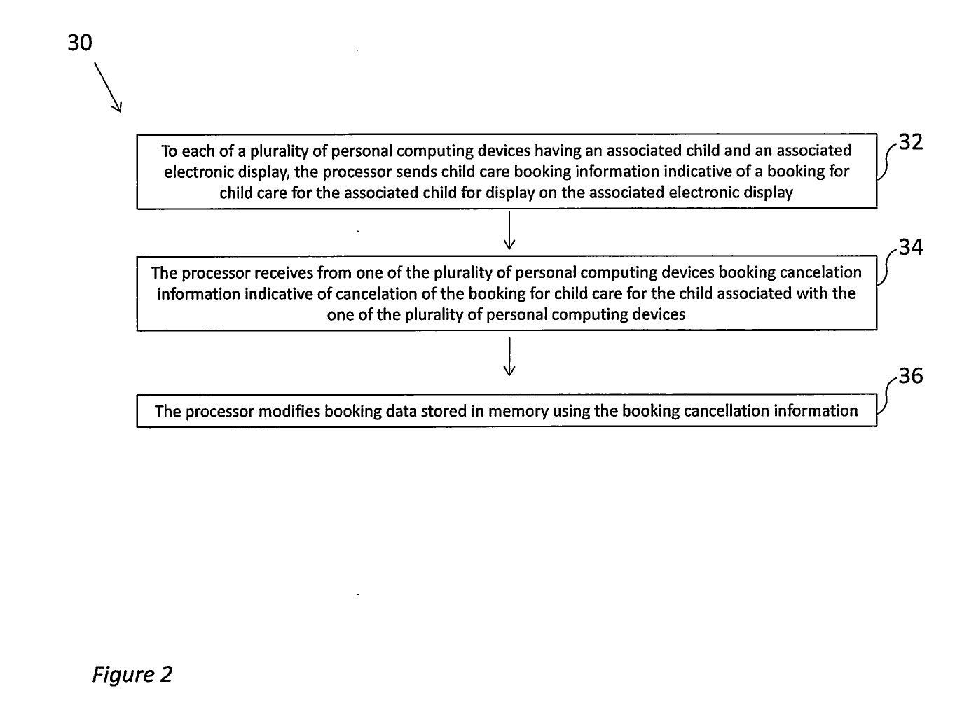

The memory 14 of the processor 10 has instructions executable by the microprocessor 12. When the processor 10 executes the instructions, the processor 10 is operable to perform the steps of an embodiment of a method 30 represented by the flow chart of FIG. 2.

In one step 32 of the embodiment of the method 30, to each of the plurality of personal computing devices 38, 40, 42 having an associated child and an associated electronic display 39, the processor 10 sends child care booking information indicative of a booking for child care for the associated child for display on the associated electronic display. In a second step 34, the processor receives from one of the plurality of personal computing devices 38 booking cancelation information indicative of cancelation of the booking for child care for the child associated with the one of the plurality of personal computing devices. In a third step 36, the processor modifies booking data stored in memory using the booking cancellation information. In this but not necessarily in all embodiments, the booking data comprises child care center booking data.

The booking may have been for, for example, child care from 9 am to 12 pm on a Monday, in which case the period of the cancelled booking is 9 am to 12 pm on the Monday, and the start time is 9 am.

The processor 10, in this but not necessarily in all embodiments, sends an email to the child care provider to notify them that a booking cancelation has been made through it.

The booking data 44, for example child care center booking data, may be stored in any one of a number of forms, examples of which include but are not limited to an array of record data structures, a sequence of containers, a doubly linked list of containers, and a database. The booking data may be indicative of at least one of the child associated with the personal computing device of the user. The instructions in the memory 14 include data base queries to retrieve the relevant records for processing, and field modification instructions to change the data to reflect changes to the bookings and time slots, for example at least one of the child booked in, the user that made the booking, the period of the booking, and the start time of the booking. Generally, the booking data is modified to indicate that the user of the one of the plurality of personal computing devices has booked for child care from the start time of the cancelled booking. The data base may be implemented in any suitable manner, for example by purpose written code in a language such as C++ or PYTHON, or using existing data base software installed on the processor 10. In the present examples, the data base software is a NoSQL database using MongoDB™. Alternatively, the data base software may be SQL or any other suitable type of database. An application program interface may provide access to the database. In embodiments using a relational data base structure, the relational database structure has a plurality of tables. For example, the data base may have a child details table. The database may have a table for responsible persons. The database may have a table for child care time slots. The database may have a table for the location of the child care (e.g., a room) within the child care center.

In this but not necessarily in all embodiments, the booking data 44 is child care center booking data. The child care center booking data may be indicative of a period in which child care is provided at the child care center. The child care center booking data may be indicative of a plurality of people (i.e., children) booked for child care during the period at the child care center. The child care center booking data may be indicative of a location, for example a room, in which the child care is provided.

There may be more than one cancelled booking for a time slot. The embodiments described herein are applicable to the case of more than one cancelled booking for a time slot.

The users are generally persons responsible for the plurality of children, for example parents and guardians. In this but not necessarily in all examples, the plurality of children are registered with a child care center 23. The details of the plurality of children are stored in the memory 14, as is personal computing device identification information (for example, a phone number of the personal computing device in the case it is a smart phone, and/or the login details entered through a personal computing device). Each child is associated with personal computing device identification information by, for example, putting child details and identification information for a personal computing device in the same data base record or by some other way.

The method 30 may generally be used to cancel a booking for any one of the children registered with the child care center. Other users may subsequently be offered care of any other child registered with the child care center from the start time or during the period of the cancelled booking.

The processor 10 is, in this embodiment, located remote from a child care center. A child care center computing device 22 associated with the child care center 23 is generally, but not necessarily, located at the child care center 23 and is in communication via the network 18 with the processor 10 and operable by a child care center representative, for example a child care center manager. In alternative embodiments, however, the processor 10 may be located at the child care center, in which case the processor may provide a user interface which may include for example an electronic display, a mouse and keyboard, or generally any suitable user interface. The user interface may be, for example, operated to instruct the child care center computing device 22 to display bookings, view details of user's children registered at the child care center, cancel a booking (including marking a child as being or will be absent), etc. The child care center representative may operate the computing device 22.

In this embodiment, the user that interacts with the one of the plurality of personal communication devices 38 to generate the booking cancelation information does not receive a refund for the cancelled booking.

The user that interacts with the one of the plurality of personal communication devices 38 to generate the booking cancelation information, in this but not all embodiments, is provided with an incentive to do so. The incentive is in the form of a donation to a charity, however any suitable incentive may be provided, for example a payment to the user that is less than the cost of the child care. The donation or payment may have a value of a few dollars or generally any suitable value.

In other embodiments, however, the user that generates the booking cancellation information does receive a refund. The refund may be conditional on a refund condition being meet. For example, the refund condition may include, for example, at least one of:
the user generated the booking cancellation at least a minimum notice time before the booking, for example 1 week before the booking; and
the user is a participant in a flexible child care plan that allows refunds for cancellations.

### Processor

The processor 10 will now be described in more detail. The processor 10 stores instructions in memory 14. The memory 14 includes nonvolatile memory in the form of at least one of a hard disk drive, solid state memory, FLASH, EPROM or any other form of processor or computer readable tangible media within or external of the processor. The instructions generally, but not necessarily, comprise a plurality of software modules that cooperate when installed on the processor 10 so that the steps of embodiments of the methods may be executed. The software modules, at least in part, correspond to the steps of the method or modules of the systems described above. The functions or components may be compartmentalised into modules or may be fragmented across several software modules. The software modules may be formed using any suitable language, examples of which include C++ and assembly. The modules may comprise a plurality of threads running on the microprocessor 12—which may have more than one core. Inter module communication may be achieved using inter-process communication methods such as file sharing, signalling, sockets, message queues, pipes, memory sharing, message passing, memory-mapped file sharing, or any other suitable method or Application Program Interface. The microprocessor 12 may be any suitable micro processor, for example an INTEL XEON or AMD OPTERON micro processor connected over a bus to a volatile memory component of memory 14 in the form of random access memory of around 10 GB. An alternative embodiment has two or more microprocessors. The processor 10 has input/output interfaces 16 which includes a network interface in the form of a network interface card in this but not necessarily all embodiments, and a universal serial bus. In other embodiments the network interface may be in the form of a USB interface into which is received a USB modem dongle or a WiFi module. The communications interface 16 may comprise at least one of these network interfaces. The processor may support a human machine interface 20 that includes, for example, a mouse and a keyboard in communication with the universal serial bus, and a display in communication with a display port, for example. The processor 10 is in the form of a computer or computer server, examples of which include a Dell PowerEdge™ server and a personal computer. The processor may be a virtual server, for example an AMAZON™ server.

The instructions executable by the processor 10 are generally in the form of software, but may in some embodiments take the form of firmware or may be entirely hardware based. The processor may be configured by a single application.

In yet another embodiment, the processor runs two applications that communicate via an Application Program Interface (API). One of the applications may be, for example, existing child care management software “KIDSOFT” running on the processor 10 that provides some child care center management functions and is used by child care center representatives to enter and delete bookings, record child details, and track payments, for example. The other application runs on the same processor 10 and communicates with KIDSOFT software via the API and the personal communication devices 38-42 to provide the functionality described herein. The processor may comprise two machines, one having child care management software, the other having the other application communicating with the child care management software via an API and a network.

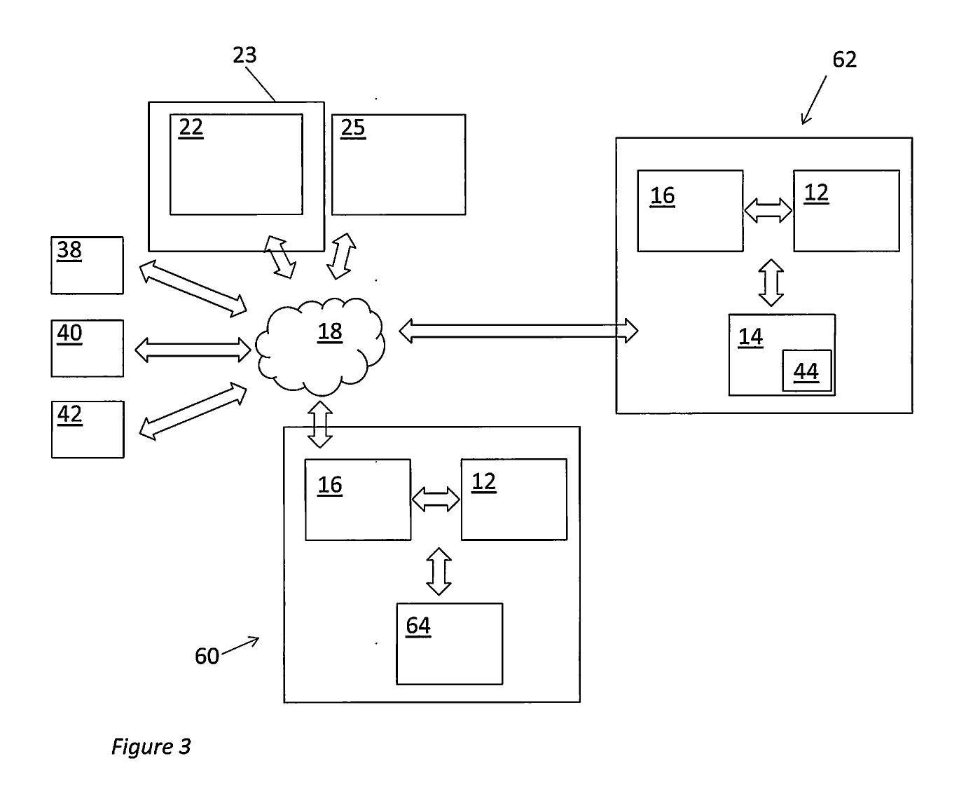

FIG. 3 shows another embodiment of the processor 60, where parts of similar form and/or function to those of FIG. 1 are similarly numbered. The processor 60 comprises a computer server that communicates with the plurality of personal computing devices 38, 40, 42 over the network 18. The processor 60 may be generally located anywhere and comprises a suitably programmed computer server (having the same general architecture as the processor 10, for example), however it may alternatively be a virtual computer server or machine provided by the AMAZON™ Elastic Compute Cloud (Amazon EC2), or generally any suitable computer server, or cluster of computer servers, whether virtual or otherwise.

The processor 60 is arranged to cooperate with another processor 62 in the form of another computer server. The server 60 and other server 62 are in this example operated by different entities and are located in different cities, and communicate via the Internet 18. They may, however, be operated by the same entity and in the same room and communicate via a local network 18. The other processor 62 may also be generally located anywhere and comprises a suitably programmed computer server, however it may alternatively be a virtual computer server. The server 62 has child care management software, for example “KIDSOFT”. The processor 60 executes the embodiments of the method of FIG. 2 or variants thereof as described with respect to the processor 10 of FIG. 1. The processor 60 has the same or similar structure to processor 10, however other embodiments may have different architectures. The details of parents and children registered with the child care center are stored in database 44 of memory 14 of the processor 62. The functions of processor 60 may be provided as an optional “plug in” to the existing child care management service provided by KIDSOFT, for example. Thus, the capabilities of the processor 62 may be augmented by processor 60 which provides hitherto unavailable functionality. The processor 60 may cache information received from the data base 44 in memory 64. Cached information may include, for example, registered center information indicative of a plurality of centers registered from the database 64, registered center phone number information indicative of the phone numbers of the plurality of centers, registered center name information indicative of the names of the plurality of centers, registered center capacity information indicative of the capacity and/or age group for each child care room in each of the plurality of centers (e.g., “red” room is for 1-2 year olds and can hold 10 children, “green” room is for 3-5 year olds and can hold 15 children, etc.), and registered child information indicative of the age and/or name and/or other details of the children registered with each of the plurality of child care centers. The processor 60 may also calculate information from information from the other processor 62 and/or cached in memory 64. For example, the processor 60 may request and receive from the other processor 64 information indicative of the number of children booked for a room at a selected time. Using this information, and cached information on the room capacity, the processor 60 may calculate if staff should be asked not to come in to work. The calculated result may be included in a notification.

In this embodiment, the processor 60 and other processor 62 communicate using an API provided by the child care management software, in the form of a hypertext transfer protocol (HTTP) API. A transmission control (TCP) session may be started between the processor 60 and the other processor 62, and on this layer a HTTP session or secure hypertext transfer protocol session (HTTPS) may commence between the processor 60 and other processor 62 (both HTTP and HTTPS are referred herein as HTTP for convenience). The API provided by the child care management software receive commands and requests using a HTTP POST or generally any suitable form of HTTP post or other request. Responses to commands and requests may be sent by the child care management software via the API in JSON format over the HTTP session. It will be appreciated that the API may take any suitable form, and may not use HTTP or JSON.

The API becomes active by the processor 60 sending via the HTTP session a security key in the form of a string of symbols to the processor 62 and the processor 62 confirming that the security key is a valid security key.

An example of a session in now described for the embodiment of the system shown in FIG. 3. A user inputs a mobile (or cell) phone number on their personal computing device 38 in communication with the processor 60. The phone number is sent to the processor 60 by the personal computing device. The processor 60 sends a request via the API to the other processor 62 to confirm that the mobile phone number is linked with a parent or guardian that is registered with a child care center. If confirmed by the other processor 62, the other processor 62 causes a confirmation code to be sent to the device 38 having the phone number via a short message service (SMS). The user may then input the confirmation code on their personal computing device which is subsequently sent to the processor 60. The processor 60 then sends the confirmation code and the phone number to the other processor 62. The processor 62 on receipt of a valid confirmation code and phone number combination provides an access token in the form of a plurality of symbols to the processor 60. The processor may subsequently use the access token to obtain details from the other processor 62 and change details on the other processor 62, the details being associated with the user, for example children registered with the child care center under the user's name, bookings, etc.

For example, the processor 60 may make the following POST request of the other processor 62, the request being for information indicative of bookings by a user between a start date and an end date:
https://app.kidsoft.com.au/api/v1/KindyNow/getBooking

The parameters of the POST request include, in this but not all examples, the API key, access token. The booking times (e.g. booking start time and/or booking end time) or booking identification information may be included, either of which are sufficient to determine the start time of the booking. The processor 62 may respond with, for example, symbols in JSON format, for example:

{“Bookings”: [ ],
“Status”: “OK” }

The details of the bookings would generally be located between “[” and “]”. In this example, however, there are no bookings.

The processor 60, on receiving cancellation information, makes a POST request to change the status of the booking in the other processor 62 so that the child is marked as absent. Alternatively, the processor 60 may make a POST request to clear all user/child information from the booking, leaving it open again.

Generally, but not necessarily, the information, received and sent by the processor (or processors, depending on the embodiment) 10, 60, 62 and the plurality of personal computing devices comprise packets. The packets generally, but not necessarily, comprise, for example, a header, and a payload. The packets may also have a trailer. The packets may be structured in accordance with the Open Systems Interconnection Model or Internet Protocol Suite (IPS), in which each payload may be itself another packet of another layer of the OSI model or IPS. For example, at the physical layer the packet is a collection of bits. The physical layer packet may comprise a data link packet having a datalink header, a datalink payload and a datalink trailer. The datalink payload may in turn comprise a Network data packet such as an IP packet. The IP packet payload may comprise a TCP or UDP packet (“segment”). This layered structure may continue to the Application layer.

While some of the network connections described above may comprise optical and/or electrical Ethernet (for example 10 Mb, 40 Mb, 1Gb, 10Gb, 40Gb, 100Gb, 400Gb, 1 Tb), it will be understood that other network types and protocols may be used, such as INFINIBAND, WiFi, and cellular networks and their protocols. Generally, any packet or non packet based protocol may be used. Alternatively or additionally, one or more of the network connections may alternatively be a serial port connection, a USB port connection, a FireWire™ port connection, a ThunderBolt™ port connection, a PCI or PCIe connection, a SONET (or SDH) connection with or without a sonnet demultiplexing device, or generally any suitable type of connection.

Other forms of processor may be used as suitable. For example, alternative logic devices may be used in place of the microprocessor 12. Examples of suitable alternative logic devices include application-specific integrated circuits, FPGAs, and digital signal processing units. Some of these embodiments may be entirely hardware based for further latency reduction. In another embodiment, the processor may comprise a networked plurality of computers or processors, or be a virtual machine within computer hardware. Generally, the processor may take any suitable form. The modules may comprise hardware modules.

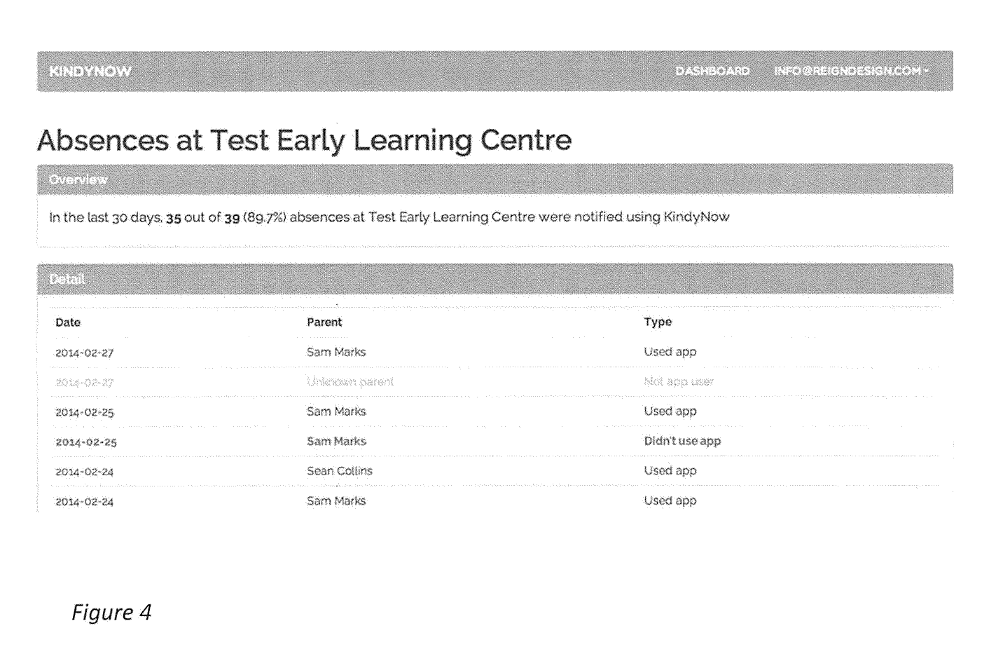

FIG. 4 shows a screen shot of the contents of a web browser window displayed by the child care center computing device 22, being a representation of information received from the processor 10, 60. The information is in the form of personal computing device usage information indicative of the usage of the plurality of personal computing devices to cancel bookings for child care. FIG. 4, for example, shows that a booking cancellation that was not requested by a personal computing device (“Didn't use App”). In some but not all embodiments, the processor 10, 60 is arranged to send a message by, for example, SMS or any other suitable channel to a user that cancelled a booking for child care through a channel other than the personal computing devices. The message may comprise information encouraging the user to use a personal computing device to cancel a booking in the future.

### Personal Computing Devices

The personal computing devices 38, 40, 42 may generally be any suitable personal computing device, examples of which include but are not limited to smart phones (for example an APPLE IPHONE or SAMSUNG GALAXY SII), and tablet computers (for example an APPLE IPAD, SAMSUNG GALAXY Tab3). In the example of FIG. 1, the personnel computing devices include at least one of a smartphone (personal computing devices 38 and 40) and a tablet computer (personal computing device 42). Generally, the personal computing devices each have a user interface in the form of a touch sensitive electronic display 39. Other examples may have a keypad and electronic display.

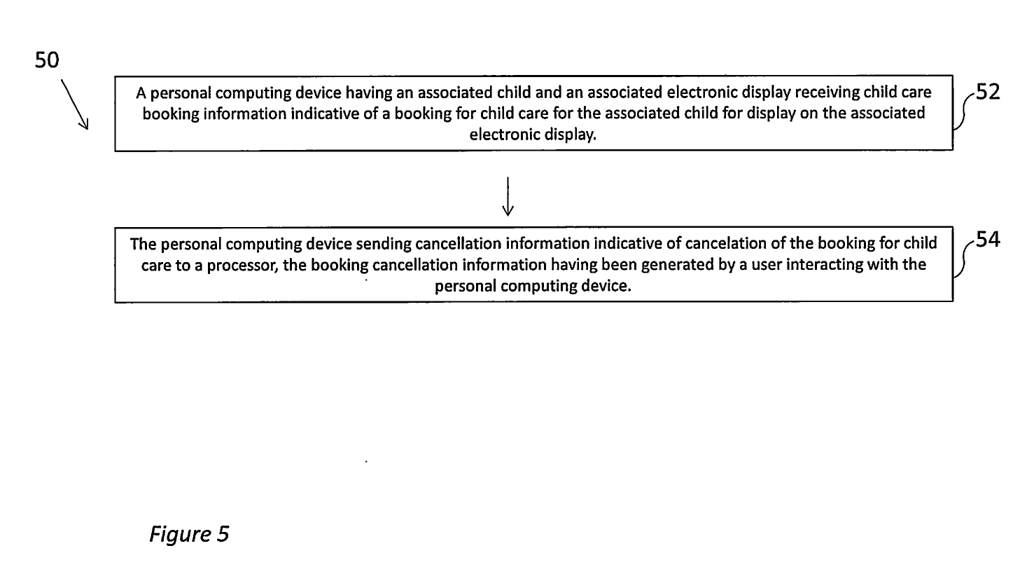

The personal computing devices are configured to connect to the processor 10, 60 via, for example, the communication conduit 18. The connection may include a 3G, 4G, WiFi or other wireless and/or wired network. In this but not necessarily in all embodiments, the personal computing devices are arranged to establish a transport control protocol (TCP) session with the processor 10, 60, and a HTTP session on the TCP layer. Information is generally exchanged between the personal computing devices and the processor 10 using HTTP requests GET and/or POST, with responses from the processor 10, 60 having response information in JSON format. Other protocols, formats, and physical connection types may be used as suitable. For example, UDP or SCTP sessions may be established instead, and proprietary application layer protocols employed. A user of a personal communication device 38, 40, 42 may download and install thereon an application in the form of, for example, an App from, for example, the Apple App or iTunes store, Google Play. The App may be started by a user of the personal communication device so that the user can interact remotely via the internet or other communication conduit with the processor 10, 60. When the App is running, the personal communication device is configured to take part in the execution of the example methods of FIGS. 2 and 5, for example.

The App may be built using IOS SDK, XCode, Android Studio, Android Software Development Kit “SDK” or APP INVENTOR, by Google Labs, for example, or generally any suitable environment and language.

Using the personal computing devices running the App, an embodiment of a method 50 shown in FIG. 5 may be executed. In one step 52, a personal computing device 38 having an associated child and an associated electronic display receives child care booking information indicative of a booking for child care for the associated child for display on the associated electronic display. In a second step 54, the personal computing device sends cancellation information indicative of cancelation of the booking for child care to the processor 10, 60. The booking cancellation information has been generated by a user interacting with the personal computing device.

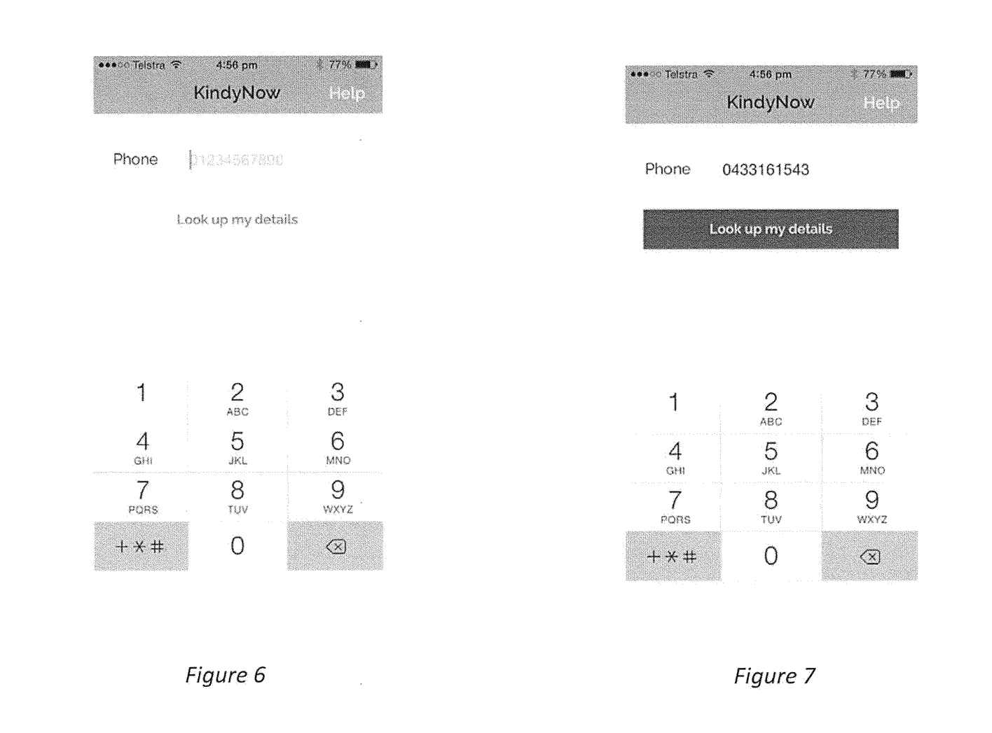

FIGS. 6 to 16 are screen shots of user interfaces in the form of touch screens of each of the plurality of personal computing devices 38, 40, 42 that are configured by the App thereon. At least some of the images displayed by the user interfaces may be generated during execution of the methods 30 and 50, for example. FIG. 6 shows a displayed keypad that enables the user to sign up by inputting their mobile phone number by touching a plurality of buttons displayed on the touchscreen.

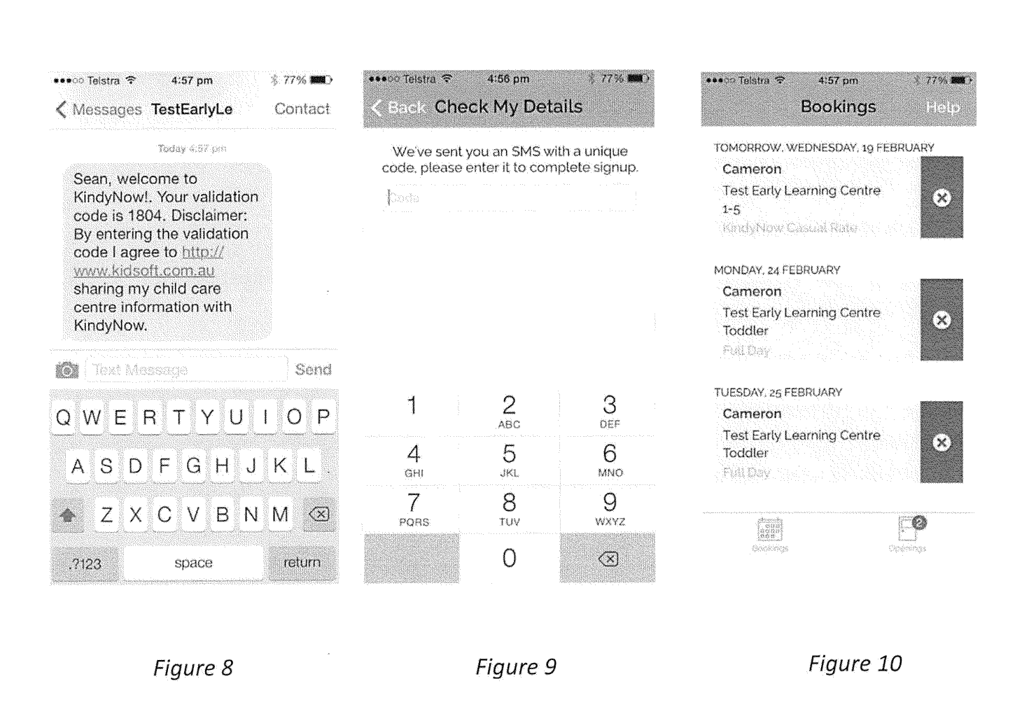

FIG. 7 shows an image displayed on the touch screen after the user enters the mobile phone number, the image confirming the connection between the personal computation device and the processor 10. FIG. 8 shows a user interface showing a validation code received by the personal computing device via SMS or another channel. The user is asked to enter the validation code to share child information with the processor 10. FIG. 9 shows a user interface that enables a user to type in the code to complete the sign up or registration process. FIG. 10 shows a user interface including displayed bookings data held by the processor 10, 60. In this but not necessarily in all examples, the user can cancel a booking of theirs by touching the screen at the position of a displayed cross associated (in this case adjacent) with the booking.

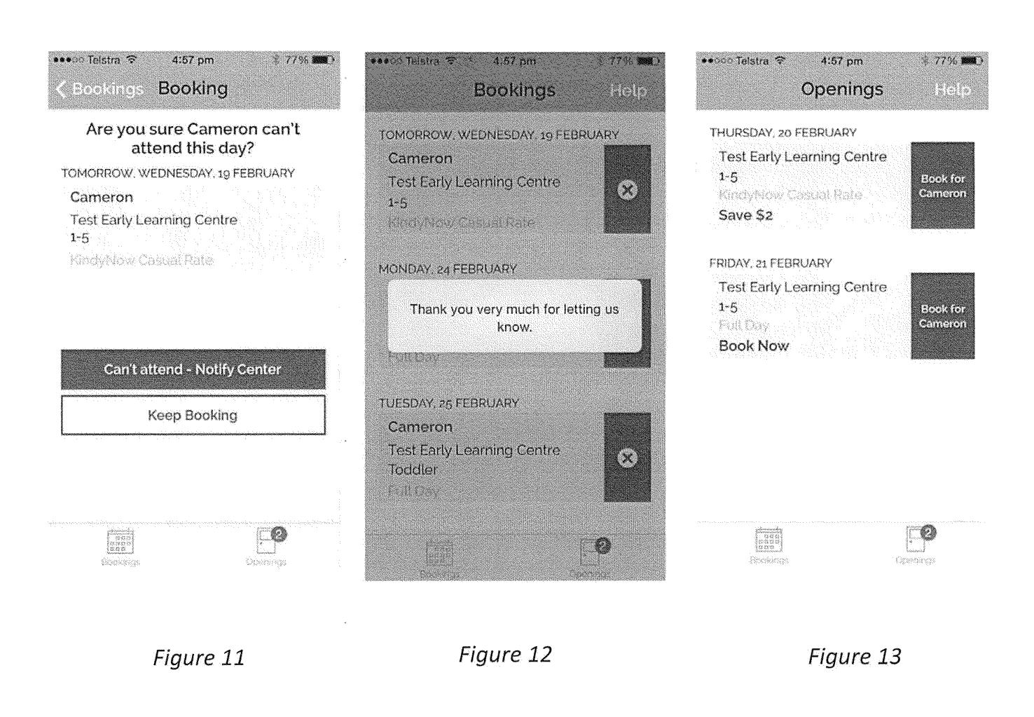

FIG. 11 shows a user interface presented during confirmation of the cancellation. The user can confirm cancelation by pressing a button, in this example, by touching the touchscreen at the displayed text “Can't attend—Notify center”. Alternatively, the user can cancel the cancelation request and so keep the booking by touching the touchscreen at the displayed text “Keep Booking”. FIG. 12 shows a displayed image wherein the personal communication device thanks the user for letting the child care center, via the processor 10, know that the booking is cancelled. The processor 10 then updates the booking data 44.

FIG. 13 shows a displayed image including displayed information indicative of available time slots for care of a child at the child care center. In this embodiment, the personal computing device is configured to only display information indicative of available time slots for days without a booking for the child. Incentives, for example in the form of a financial or other incentive, may be provided, in this example a discount of $2 is offered for a booking on Thursday 20 February. The incentives may, for example, entice a booking on a day on which demand is low, for example, or for which there have been cancellations. In this example, the child care availability information comprises incentive information indicative of the incentive for making a booking. For example, the incentive information may indicate which start time has an incentive attached. The incentive information in this but not all embodiments may indicate the value of the incentive. An available time for child care may be more likely to be filled when the incentive is provided. The quantity of incentive may be dependent on the quantity of time to the time child care starts. For example, an incentive may be provided for booking an available time in the near future (for example, within the predetermined time period). An incentive may not be provided for booking another available time not in the near future. Suitable incentives may include gifts of tangible and/or intangible goods, vouchers for discounts for other services, or generally any other suitable incentive.

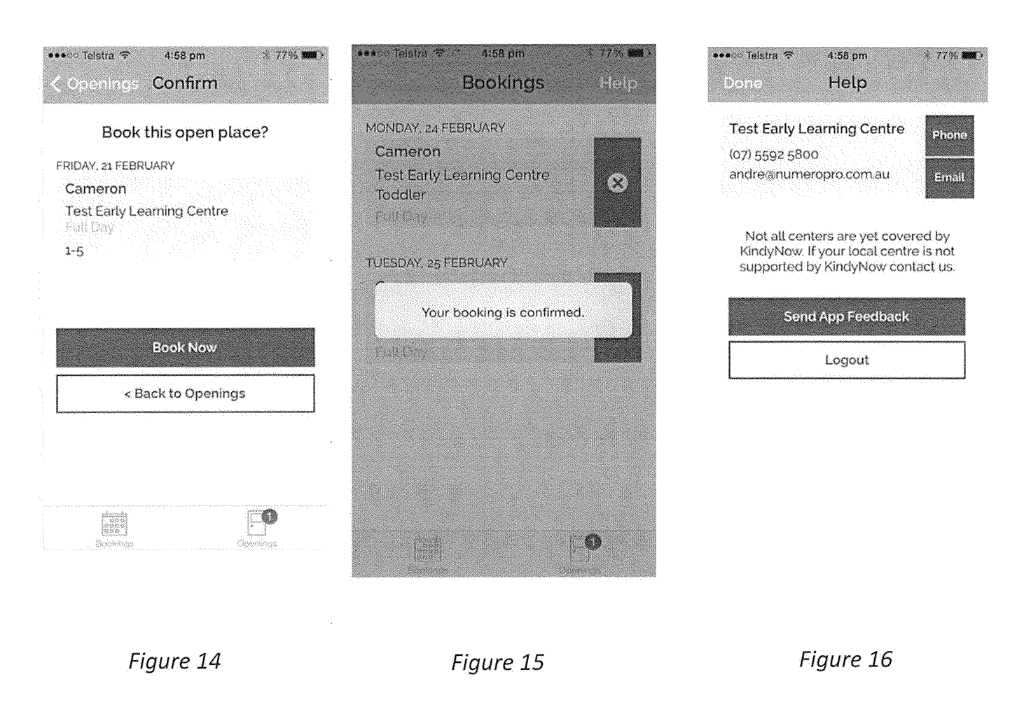

FIG. 14 shows a user interface presented when a user makes a booking at an available time slot. The user may press the “Book Now” button by touching the touchscreen at the text “Book now” to make the booking. FIG. 15 shows a displayed image advising the user that the booking is confirmed. FIG. 16 shows a displayed image of a “help” screen, which includes the user's child care center's phone number and/or email address.

Alternatively, the personal computing device may be a personal computer (for example a personal computer running MICROSOFT WINDOWS or MAC OS), which may be, for example, a desktop or laptop personal computer. The personal computer has a user interface that may include, for example, an electronic display, a keyboard, a mouse and/or a touchpad. The user interfaces may be adjusted for use of these hardware interfaces rather than a touch screen.

### Child Care Center Computing Device

The child care center computing device 22 is, in this but not necessarily in all embodiments, in the form of a personal computer. In this but not necessarily in all embodiments, for example, the child care center computing device 22 has web browser software in the form of MICROSOFT INTERNET EXPLORER (although any suitable web browser may be used, further examples of which include CHROME, and FIREFOX). Operation of the web browser on the computing device 22 by the user may cause the computing device 22 to receive from the processor 10 information including current bookings for the care of children at the child care center and/or time slots for which there is currently no booking. The received information is generally displayable by the web browser on the child care center computing device 22.

The processor 10 serves, in the example of FIG. 1, a plurality of child care center computing devices 22, 25. The processor may serve more or less than two child care center computing devices 22, 25. Generally, each computing device 22,25 is for a different child care center, however more than one child care center computing device may be for a particular child care center, for example one device 22 may be for management and another may be for reception.

In this but not necessarily in all examples, the child care center representative may view their own custom dashboard displayed by the computing device 22 which allows them to configure the processor 10. Configuration options include:
Offering discounts for bookings, for example, for last minute bookings which have been grouped by days out (eg. 1 day, 2-3 days and above 4 days);
Offer a discount for a user that has cancelled a booking;
Sending notifications to a user asking if their child is attending each day;

The dashboard may also display:
Penetration: The number of parents that have downloaded an App onto their personal computing device to allow them to interact with the processor 10;
Absentees Notified: The number of bookings cancelled;
Detailed notifications: Time and parent who made the cancellation.

Now that embodiments have been described, it will be appreciated that some embodiments have some of the following advantages:
A booking cancelation may be made with little or no input by a child care provider representative.
The child care center may be informed more often of cancelations because of a sick children—a common occurrence in child care—and appropriate action taken.
The processor may react immediately when a booking is cancelled, for example, by notifying others of a vacancy.
Booking management is controlled by users (eg. parents and guardians) rather than the child care providers which previously has not been possible in the applicants best knowledge, which may be convenient for users.
The fact the users don't have to call the child care provider to make cancellations during the child care provider representative's time (after hours even) may reduce labour and costs.
Incentives may be provided that increase child care provider profitability.

Variations and/or modifications may be made to the embodiments described without departing from the spirit or ambit of the invention. For example, the network may be a local area network or a wide area network. The present embodiments are, therefore, to be considered in all respects as illustrative and not restrictive.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1. A method for automated child care booking management, the method comprising the steps of:
to each of a plurality of personal computing devices having an associated child and an associated electronic display, a processor sending child care booking information indicative of a booking for child care for the associated child for display on the associated electronic display;
the processor receiving from one of the plurality of personal computing devices booking cancelation information indicative of cancelation of the booking for child care for the child associated with the one of the plurality of personal computing devices; and
the processor modifying booking data stored in memory using the booking cancellation information.

2. A method defined by claim 1 wherein the method is for automated child care booking management for a child care center.

3. A method defined by claim 2 wherein the booking for child care is for child care at a child care center.

4. A method defined by claim 3 wherein the booking data comprises child care center booking data.

5. A method defined by claim 1 wherein the cancelation information is generated by a user interacting with the one of the plurality of personal computing devices

6. A processor for automated child care booking management, the processor comprising at least one microprocessor, a memory, and a communications interface for providing access to a communications conduit, the memory comprises instructions executable by the at least one microprocessor such that the processor is operable to:
to each of a plurality of personal computing devices having an associated child and an associated electronic display, send child care booking information indicative of a booking for child care for the associated child for display on the associated electronic display;
receive from one of the plurality of personal computing devices booking cancelation information indicative of cancelation of the booking for child care for the child associated with the one of the plurality of personal computing devices; and
modify booking data stored in memory using the booking cancellation information.

7. A processor defined by claim 6 wherein the processor is for automated child care booking management for a child care center.

8. A processor defined by claim 7 wherein the booking for child care is for child care at a child care center.

9. A processor defined by claim 8 wherein the booking data is child care center booking data.

10. A method for automated child care booking management, the method comprising the steps of:
a personal computing device having an associated child and an associated electronic display receiving child care booking information indicative of a booking for child care for the associated child for display on the associated electronic display; and
the personal computing device sending cancellation information indicative of cancelation of the booking for child care to a processor, the booking cancellation information having been generated by a user interacting with the personal computing device.

11. A system for automated child care booking management, the system comprising:
a personal computing device and a processor arranged to communicate with each other, the personal computing device being arranged for a user to interact therewith to generate booking cancellation information indicative of cancelation of the booking for child care, the personal computing device being arranged to send the cancellation information indicative of cancelation of the booking for child care to the processor, and the processor being further arranged to modify booking data stored in memory using the booking cancellation information.
